(19) United States
(12) Patent Application Publication
(10) Pub. No.: US 2026/0233739 A1
(43) Pub. Date: Aug. 13, 2026

(54) METHOD AND SYSTEM FOR ADJUSTING CRUISE CONTROL MODE THROUGH DETECTION OF CUT-OUT VEHICLE

(71) Applicant: HL Klemove Corp., Incheon (KR)

(72) Inventor: Boryeon KANG, Incheon (KR)

(73) Assignee: HL Klemove Corp., Incheon (KR)

(21) Appl. No.: 19/206,662

(22) Filed: May 13, 2025

(30) Foreign Application Priority Data
Feb. 12, 2025 (KR) 10-2025-0017891

(51) Int. Cl. B60W 30/16; B60W 10/06; B60W 30/02; B60W 40/04; B60W 40/107; B60W 50/14

(52) U.S. Cl. CPC B60W 30/162; B60W 10/06; B60W 40/04; B60W 40/107; B60W 50/14; B60W 30/02; B60W 2050/146; B60W 2420/403; B60W 2420/408; B60W 2552/10; B60W 2554/4041; B60W 2554/4044; B60W 2554/4045; B60W 2710/06; B60W 2720/106; B60W 2754/30

(57) ABSTRACT

A method and a system for adjusting a cruise control mode through detection of a cut-out vehicle are provided, and the method for adjusting the cruise control mode through detection of the cut-out vehicle according to an embodiment of the present disclosure comprises: recognizing a front vehicle and a lane; determining whether the front vehicle is a cut-out vehicle; if the front vehicle is the cut-out vehicle, calculating an overlapping area between a driving lane of an ego vehicle and the front vehicle; adjusting a cruise control mode of the ego vehicle based on the overlapping area and a heading angle of the front vehicle; and controlling driving of the ego vehicle based on the adjusted cruise control mode.

### CROSS-REFERENCE TO RELATED APPLICATION

This application claims the benefit of and priority to Korean Patent Application No. 2025-0017891 filed on Feb. 12, 2025, the entire disclosures of which are incorporated herein by reference.

### TECHNICAL FIELD

The present disclosure relates to a method and system for adjusting a cruise control mode through detection of a cut-out vehicle. More specifically, the present disclosure relates to a method and system for adjusting a cruise control mode through detection of a cut-out vehicle, capable of finely adjusting the cruise control mode according to a cut-out state by determining a cut-out level for a cut-out vehicle.

### BACKGROUND

In a vehicle, a Driver Assistance System provides support to the driver while driving for the driver's convenience.

For example, among driver assistance systems, a cruise control system is a technology that maintains a constant driving speed. When a preceding vehicle is detected, it controls the vehicle's speed based on the distance to the preceding vehicle to maintain a constant gap.

Such cruise control is also referred to as Active Cruise Control (ACC), adaptive cruise control, Smart Cruise Control (SCC), Advanced Smart Cruise Control, or Dynamic Radar Cruise Control (DRCC).

Such a cruise control system utilizes information about a front vehicle (target vehicle) detected by sensors to perform acceleration or deceleration control of the ego vehicle, thereby controlling the driving speed and the inter-vehicle distance to the front vehicle.

Meanwhile, in a situation where the front vehicle (target vehicle) is cutting out, the front vehicle may soon be excluded from being the target vehicle. If such a situation is not considered, driving according to the cruise control system may not be effective.

Therefore, there is a need for a method and system for adjusting the cruise control mode that can improve the performance of the cruise control system by considering the case where the target vehicle is a cut-out vehicle and adjusting the cruise control mode accordingly.

### SUMMARY

The present disclosure is intended to solve the problems of the prior art described above, and an object of the present disclosure is to provide a method and system for adjusting a cruise control mode through detection of a cut-out vehicle, which adjusts the cruise control mode based on the overlap area and heading angle of a front vehicle when the front vehicle is cutting out.

Further, an object of the present disclosure is to provide a method and system for adjusting a cruise control mode through detection of a cut-out vehicle, which determines a cut-out level based on the overlap area and heading angle of a cutting-out front vehicle, and adjusts the headway distance and acceleration according to the determined cut-out level.

However, the technical problems to be achieved by the embodiments of the present disclosure are not limited to the technical problems described above, and other technical problems may exist.

As a technical means for achieving the above technical problem, a method for adjusting a cruise control mode through detection of a cut-out vehicle according to an embodiment of the present disclosure comprises: recognizing a front vehicle and a lane; determining whether the front vehicle is a cut-out vehicle; if the front vehicle is the cut-out vehicle, calculating an overlapping area between a driving lane of an ego vehicle and the front vehicle; adjusting a cruise control mode of the ego vehicle based on the overlapping area and a heading angle of the front vehicle; and controlling driving of the ego vehicle based on the adjusted cruise control mode.

Further, the determining of whether the front vehicle is the cut-out vehicle may comprise: determining whether at least a part of the front vehicle is within the driving lane of the ego vehicle.

Further, the determining of whether the front vehicle is the cut-out vehicle may further comprise: receiving information regarding a longitudinal position, a lateral position, a length, a width, and the heading angle of the front vehicle.

Further, the determining of whether the front vehicle is the cut-out vehicle may further comprise: determining whether the front vehicle is the cut-out vehicle based on the received information.

Further, the calculating of the overlapping area may comprise: identifying positions of four vertices of the front vehicle from the received information; and calculating the overlapping area based on the positions of the four vertices and recognized lane information.

Further, the adjusting of the cruise control mode may comprise: determining a cut-out level based on the overlapping area and the heading angle of the front vehicle, and wherein the cut-out level may increase as the overlapping area decreases and as the heading angle of the front vehicle increases.

Further, the adjusting of the cruise control mode may further comprise: calculating a headway distance between the ego vehicle and the front vehicle based on the determined cut-out level; and calculating an acceleration amount of the ego vehicle based on the determined cut-out level, and wherein the headway distance and the acceleration amount may be calculated such that the headway distance decreases and the acceleration amount increases as the cut-out level increases.

Further, the adjusting of the cruise control mode may further comprise: adjusting the cruise control mode based on the calculated headway distance and the calculated acceleration amount.

Further, the method may further comprise: after the cut-out level is determined, displaying the determined cut-out level on a display apparatus installed inside the ego vehicle.

Further, the method may further comprise: when the cut-out of the front vehicle is completed, resetting a surrounding vehicle located ahead of the front vehicle and located in the driving lane of the ego vehicle as a target vehicle.

A system for adjusting a cruise control mode through detection of a cut-out vehicle according to embodiments of the present disclosure comprises: a first sensor configured to recognize a front vehicle of an ego vehicle and a lane; a second sensor configured to detect body information of the ego vehicle; and a controller comprising at least one processor configured to adjust a cruise control mode of the ego vehicle based on detection information from the first sensor and the second sensor, wherein the controller is configured to: calculate an overlapping area between a driving lane of the ego vehicle and the front vehicle if the front vehicle is determined to be the cut-out vehicle based on the detection information from the first sensor and the second sensor; adjust the cruise control mode of the ego vehicle based on the overlapping area and a heading angle of the front vehicle; and control driving of the ego vehicle based on the adjusted cruise control mode.

Further, the first sensor may comprise at least one of a front camera, a front radar, or a corner radar, and wherein information regarding a longitudinal position, a lateral position, a length, a width, and the heading angle of the front vehicle may be received from the first sensor.

Further, the at least one processor may be configured to determine whether the front vehicle is the cut-out vehicle based on the information regarding the longitudinal position, the lateral position, the length, the width, and the heading angle received from the first sensor.

Further, the at least one processor may be configured to: identify positions of four vertices of the front vehicle from the received information; and calculate the overlapping area based on the positions of the four vertices and recognized lane information.

Further, the at least one processor may be configured to determine a cut-out level based on the overlapping area and the heading angle of the front vehicle, and the cut-out level may increase as the overlapping area decreases and as the heading angle of the front vehicle increases.

Further, the at least one processor may be configured to calculate a headway distance between the ego vehicle and the front vehicle and an acceleration amount of the ego vehicle such that the headway distance decreases and the acceleration amount increases as the cut-out level increases.

Further, the system may further comprise: an ESC (Electronic Stability Control) controller configured to perform longitudinal deceleration control of the ego vehicle; and an EMS (Engine Management System) controller configured to perform longitudinal acceleration control of the ego vehicle, wherein the controller may be configured to control at least one of the ESC controller or the EMS controller based on the cut-out level determined by the at least one processor, to control the driving of the ego vehicle according to the adjusted cruise control mode.

Further, the system may further comprise a display apparatus configured to display the cruise control mode of the ego vehicle, wherein the controller may be configured to display the cut-out level determined by the at least one processor on the display apparatus.

Further, the controller may be configured to reset a surrounding vehicle located ahead of the front vehicle and located in the driving lane of the ego vehicle as a target vehicle when the cut-out of the front vehicle is completed.

Meanwhile, in a non-transitory computer-readable recording medium that records a program for executing a method for adjusting a cruise control mode through detection of a cut-out vehicle according to an embodiment of the present disclosure, the method comprise: recognizing a front vehicle and a lane; determining whether the front vehicle is a cut-out vehicle; if the front vehicle is the cut-out vehicle, calculating an overlapping area between a driving lane of an ego vehicle and the front vehicle; adjusting a cruise control mode of the ego vehicle based on the overlapping area and a heading angle of the front vehicle; and controlling driving of the ego vehicle based on the adjusted cruise control mode.

The above-described means for solving the problem is only exemplary and should not be construed as limiting the present disclosure. In addition to the exemplary embodiments described above, additional embodiments may exist in the drawings and the following detailed description.

According to the problem-solving means of the present disclosure described above, when a front vehicle is a cut-out vehicle, the headway distance and acceleration according to the cruise control mode can be adjusted step-by-step based on the cut-out level, thereby providing a method and system for adjusting a cruise control mode through detection of a cut-out vehicle that can further improve cruise control performance.

Further, according to the problem-solving means of the present disclosure described above, data collected by sensors can be effectively utilized to accurately determine whether a front vehicle is a cut-out vehicle, thereby providing a method and system for adjusting a cruise control mode through detection of a cut-out vehicle that can finely adjust the cruise control mode accordingly.

However, the effects obtainable from the present disclosure are not limited to the effects described above, and other effects may exist.

### BRIEF DESCRIPTION OF THE DRAWINGS

FIG. 1 is a control flowchart showing a method for adjusting a cruise control mode through detection of a cut-out vehicle according to an embodiment of the present disclosure.

FIG. 2 is a control flowchart showing in more detail the step of determining a cut-out vehicle in the method for adjusting a cruise control mode through detection of a cut-out vehicle according to the embodiment of the present disclosure.

FIG. 3 is a control flowchart showing in more detail the step of adjusting the cruise control mode in the method for adjusting a cruise control mode through detection of a cut-out vehicle according to the embodiment of the present disclosure.

FIG. 4 is a diagram for illustratively explaining the method for adjusting a cruise control mode through detection of a cut-out vehicle according to the embodiment of the present disclosure.

FIG. 5 is a control configuration diagram schematically showing configuration of a system for adjusting a cruise control mode through detection of a cut-out vehicle according to embodiments of the present disclosure.

FIG. 6 is a diagram schematically showing a sensor data processing by the first sensor and the cut-out level determination logic by the processor according to the embodiment of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a method and system for adjusting a cruise control mode through detection of a cut-out vehicle, which adjusts the cruise control mode of the ego vehicle based on a cut-out level when the front vehicle of the ego vehicle is a cut-out vehicle.

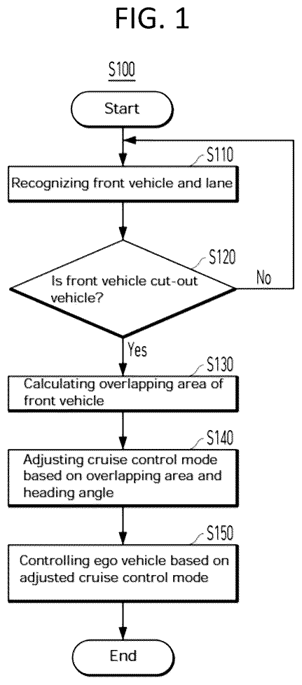

FIG. 1 is a control flowchart showing a method for adjusting a cruise control mode through detection of a cut-out vehicle according to an embodiment of the present disclosure.

Referring to FIG. 1, the method for adjusting a cruise control mode through detection of a cut-out vehicle S100 according to an embodiment of the present disclosure may include recognizing a front vehicle and a lane S110.

For example, information regarding the front vehicle and the lane may be recognized by at least one of a front camera, a front radar, or a corner radar installed in the ego vehicle. Information regarding the lane may include information about the lane lines on both sides of the driving lane of the ego vehicle, located in front of the ego vehicle.

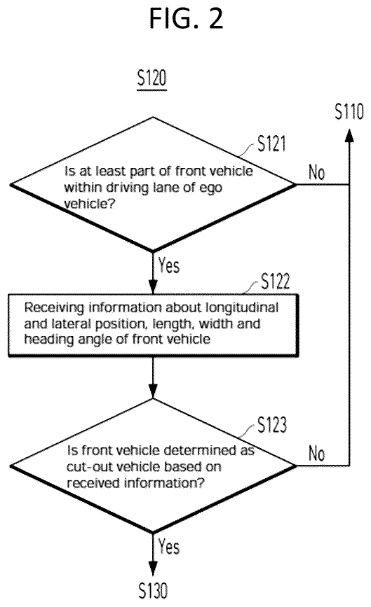

Next, determining whether the front vehicle is a cut-out vehicle S120 may be performed. A cut-out vehicle may refer to a vehicle performing a lane change from the driving lane of the ego vehicle to an adjacent lane. Whether it is a cut-out vehicle may be determined based on information such as the vehicle's position, heading angle, etc. The cut-out vehicle determination step S120 will be described in more detail with reference to FIG. 2.

If it is determined that the front vehicle is a cut-out vehicle (‘Yes’ in S120), calculating the overlapping area between the driving lane of the ego vehicle and the front vehicle S130 may be performed. On the other hand, if it is determined that the front vehicle is not a cut-out vehicle (‘No’ in S120), the process may return to the step of recognizing the front vehicle and the lane (S110).

Meanwhile, the overlapping area between the driving lane of the ego vehicle and the front vehicle may refer to the area of the portion of the front vehicle that remains within the driving lane of the ego vehicle when the front vehicle is cutting out, but not completely cut-out yet. That is, when a part of the front vehicle is located within the driving lane of the ego vehicle, the area of said part of the front vehicle viewed from above may be the overlapping area.

The overlapping area may be calculated from the recognition information of the front vehicle and the lane. Specifically, the positions of the four vertices of the front vehicle may be identified from the collected information about the front vehicle, and the overlapping area may be calculated based on the position information of the four vertices and the recognized lane information.

Subsequently, a cruise control mode adjustment step S140 of adjusting the cruise control mode of the ego vehicle based on the overlapping area and the heading angle of the front vehicle may be performed.

Here, adjusting the cruise control mode based on the overlapping area and the heading angle of the front vehicle is because the possibility of the front vehicle completely cutting out from the driving lane of the ego vehicle soon (completion of lane change) can be determined from the overlapping area and heading angle information.

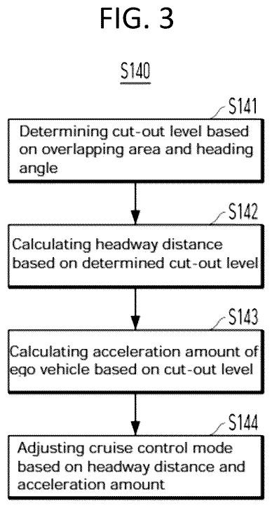

Accordingly, in the embodiment of the present disclosure, a cut-out state, i.e., a cut-out level, may be determined based on the overlapping area and the heading angle of the front vehicle, and the cruise control mode may be adjusted accordingly. The details of the cruise control mode adjustment step S140 will be described in more detail with reference to FIG. 3.

Next, controlling the driving of the ego vehicle according to the adjusted cruise control mode S150 may be performed.

According to the embodiment of the present disclosure as described above, by determining whether the front vehicle is a cut-out vehicle based on recognition information, and adjusting the cruise control mode based on the overlapping area and heading angle of the front vehicle, i.e., based on the cut-out degree, it is possible to further enhance the cruise control function of the ego vehicle.

FIG. 2 is a control flowchart showing in more detail the step of determining a cut-out vehicle in the method for adjusting a cruise control mode through detection of a cut-out vehicle according to the embodiment of the present disclosure.

Referring to FIG. 2, the cut-out vehicle determination step S120 according to the embodiment of the present disclosure may include determining whether at least a part of the recognized front vehicle is within the driving lane of the ego vehicle S121.

Here, whether at least a part of the front vehicle is within the driving lane of the ego vehicle may be determined, for example, through the front camera information of the ego vehicle.

If at least a part of the front vehicle is within the driving lane of the ego vehicle (‘Yes’ in S121), receiving information about the longitudinal position, lateral position, length, width, and heading angle of the front vehicle S122 may be performed.

This information regarding the front vehicle may be received from the sensor(s) of the ego vehicle, such as the front camera, front radar, and corner radar. Based on this information, it may be determined whether the front vehicle is a cut-out vehicle (S123). Alternatively, in addition to the information about longitudinal/lateral position, length, width, and heading angle of the front vehicle, the distance between the front vehicle and the lane line and the lateral speed of the front vehicle may be further considered to determine whether the front vehicle is cutting out.

As described above, according to the embodiment of the present disclosure, by determining whether the front vehicle is a cut-out vehicle based on information such as the longitudinal/lateral position, length, width, and heading angle of the front vehicle, it is possible to accurately determine whether the front vehicle is a cut-out vehicle.

If it is determined that the front vehicle is a cut-out vehicle (‘Yes’ in S123), the overlapping area calculation step S130 may be performed.

On the other hand, if at least a part of the front vehicle is not within the driving lane of the ego vehicle (‘No’ in S121), or if it is determined that the front vehicle is not a cut-out vehicle (‘No’ in S123) based on the received information, the process may return to the front vehicle and lane recognition step (S110).

FIG. 3 is a control flowchart showing in more detail the step of adjusting the cruise control mode in the method for adjusting a cruise control mode through detection of a cut-out vehicle according to the embodiment of the present disclosure.

Referring to FIG. 3, the cruise control mode adjustment step S140 according to the embodiment of the present disclosure may include determining a cut-out level based on the overlapping area and the heading angle of the front vehicle S141.

The cut-out level may increase as the overlapping area decreases and as the heading angle of the front vehicle increases. This is because the smaller the overlapping area and the larger the heading angle of the front vehicle, the faster the front vehicle is predicted to be to completing the cut-out (lane changing).

Meanwhile, the cut-out level may be set in stages, such as levels 1-5, or may be set in the form of assigning weights to the size of the overlapping area and the size of the heading angle.

Once the cut-out level is determined, calculating the headway distance between the ego vehicle and the front vehicle based on the determined cut-out level S142 and calculating the acceleration amount of the ego vehicle based on the determined cut-out level S143 may be performed.

In the cruise control mode, driving is performed while maintaining a certain gap (constant separation distance) with the front vehicle, and this separation distance may be expressed as the headway distance. Also, in the cruise control mode, acceleration or deceleration is performed to maintain the separation distance with the front vehicle, and the acceleration amount of the ego vehicle may refer to the acceleration required to maintain the separation distance (in case of deceleration, it may have a negative value).

Meanwhile, the headway distance and the acceleration amount of the ego vehicle may be calculated such that the headway distance decreases and the acceleration amount increases as the cut-out level increases. This is because, if the front vehicle is expected to complete the cut-out soon, since the risk of collision between the ego vehicle and the front vehicle decreases, the headway distance with the cut-out vehicle is adjusted to be decreased, and the acceleration amount is adjusted to be increased.

Next, adjusting the cruise control mode based on the calculated headway distance and the acceleration amount of the ego vehicle S144 may be performed.

Meanwhile, according to an embodiment of the present disclosure, after the cut-out level is determined, a step of displaying the determined cut-out level on a display apparatus installed in the ego vehicle may be further included. This is to inform the driver of the ego vehicle about the adjustment of the cruise control mode according to the cut-out level.

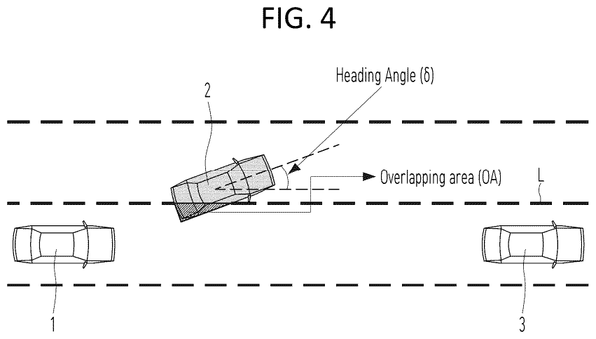

FIG. 4 is a diagram for illustratively explaining the method for adjusting a cruise control mode through detection of a cut-out vehicle according to the embodiment of the present disclosure.

Referring to FIG. 4, while the ego vehicle 1 is driving on a lane, a front vehicle 2 and a lane L may be recognized. Based on information such as the longitudinal/lateral position, length, width, and heading angle (δ) of the front vehicle 2, it may be determined whether the front vehicle 2 is cutting out to an adjacent lane.

If it is determined that the front vehicle 2 is a cut-out vehicle, the overlapping area OA between the driving lane of the ego vehicle 1 and the front vehicle 2 may be calculated. Here, the overlapping area OA may be calculated based on identifying positions of the four vertices of the front vehicle from the received information about the front vehicle, and based on the position information of the four vertices and the recognized lane information.

According to the embodiment of the present disclosure, a cut-out level may be determined based on this overlapping area OA and the heading angle δ of the front vehicle 2, and the cruise control mode of the ego vehicle 1 may be adjusted according to the determined cut-out level.

Meanwhile, when the cut-out of the front vehicle 2 is completed (lane change to the adjacent lane is completed), a surrounding vehicle 3 located ahead of the front vehicle 2 and positioned in the driving lane of the ego vehicle 1 may be reset as the target vehicle.

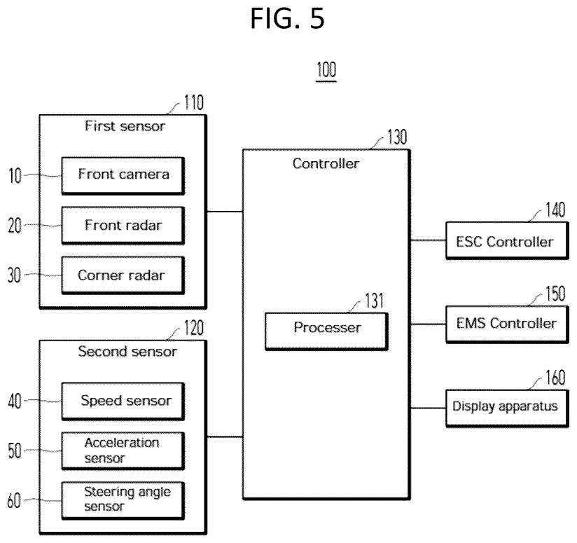

FIG. 5 is a control configuration diagram schematically showing configuration of a system for adjusting a cruise control mode through detection of a cut-out vehicle according to embodiments of the present disclosure.

Referring to FIG. 5, the system for adjusting a cruise control mode through detection of a cut-out vehicle 100 according to embodiments of the present disclosure may include: a first sensor 110 configured to recognize the front vehicle of the ego vehicle and the lane; a second sensor 120 configured to detect body information of the ego vehicle; and a controller 130 comprising at least one processor 131 configured to adjust the cruise control mode of the ego vehicle based on the detection information from the first sensor 110 and the second sensor 120.

The controller 130, based on the detection information from the first sensor 110 and the second sensor 120, may calculate the overlapping area between the driving lane of the ego vehicle and the front vehicle if it is determined that the front vehicle is a cut-out vehicle, adjust the cruise control mode of the ego vehicle based on the overlapping area and the heading angle of the front vehicle, and control the driving of the ego vehicle based on the adjusted cruise control mode.

The first sensor 110 may include at least one of a front camera 10, a front radar 20, or a corner radar 30. However, it is not limited thereto, and the first sensor 110 may include other types of sensors for detecting the vehicle's surroundings, such as ultrasonic sensors, lidar sensors, etc.

Information regarding the longitudinal position, lateral position, length, width, and heading angle of the front vehicle may be collected by the first sensor 110. Further, information regarding the distance between the front vehicle and the lane, and the lateral speed of the front vehicle may also be collected by the first sensor 110.

Based on the information received from the first sensor 110, i.e., the longitudinal position, lateral position, length, width, and heading angle information of the front vehicle, it may be determined whether the front vehicle is a cut-out vehicle. Also, whether the front vehicle is the cut-out vehicle may be determined by further considering the distance between the front vehicle and the lane, and the lateral speed of the front vehicle in addition to the above information. Furthermore, the information received by the first sensor 110 may also be used in calculating the overlapping area of the front vehicle.

The second sensor 120 may include at least one of a speed sensor 40 for detecting the speed of the ego vehicle, an acceleration sensor 50 for detecting the acceleration of the ego vehicle, or a steering angle sensor 60 for measuring the steering angle of the ego vehicle. However, it is not limited thereto, and the second sensor 120 may include other types of sensors for detecting the body information of the ego vehicle.

The at least one processor 131 included in the controller 130 may identify the positions of the four vertices of the front vehicle from the information received by the sensor(s), and calculate the overlapping area based on the position information of the four vertices and the recognized lane information.

Further, the at least one processor 131 may determine the cut-out level based on the overlapping area and the heading angle of the front vehicle. Meanwhile, the cut-out level may be determined to be increased as the overlapping area decreases and as the heading angle of the front vehicle increases.

The at least one processor 131 may calculate the headway distance between the ego vehicle and the front vehicle and the acceleration amount of the ego vehicle such that the headway distance decreases and the acceleration increases as the cut-out level increases. The cruise control mode of the ego vehicle may be then adjusted based on the calculated headway distance and the acceleration amount, and the driving of the ego vehicle may be controlled according to the adjusted cruise control mode.

Further, the system for adjusting a cruise control mode through detection of a cut-out vehicle 100 according to embodiments of the present disclosure may further comprise an ESC (Electronic Stability Control) controller 140 configured to perform longitudinal deceleration control of the ego vehicle; and an EMS (Engine Management System) controller 150 configured to perform longitudinal acceleration control of the ego vehicle.

The controller 130 may control at least one of the ESC controller 140 or the EMS controller 150 based on the cut-out level determined by the at least one processor 131, thereby performing control of the ego vehicle according to the adjusted cruise control mode.

Specifically, the controller 130 may control at least one of the ESC controller 140 or the EMS controller 150 based on the headway distance and the acceleration amount adjusted by the cruise control mode adjustment, thereby controlling the ego vehicle.

Further, the system for adjusting a cruise control mode through detection of a cut-out vehicle 100 according to embodiments of the present disclosure may further comprise a display apparatus 160 configured to display the cruise control mode of the ego vehicle.

The controller 130 may display the cut-out level determined by the at least one processor 131 on the display apparatus 160. Here, the display apparatus 160 may be an HMI (Human Machine Interface) installed inside the ego vehicle. The display apparatus 160 may display whether the cruise control mode of the ego vehicle is operating on the HMI, and additionally display the cut-out level of the front vehicle on the HMI, thereby providing a notification to the driver regarding the adjustment of the cruise control mode according to the cut-out level.

Further, the controller 130, when the cut-out of the front vehicle is completed, may reset a surrounding vehicle located ahead of the front vehicle and positioned in the driving lane of the ego vehicle as the target vehicle. Accordingly, vehicle control according to the cruise control mode may be performed based on the new target vehicle.

Regarding the method for adjusting the cruise control mode through detection of the cut-out vehicle according to the embodiment of the present disclosure performed by the controller 130, since it has been described in detail previously, a detailed description thereof will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

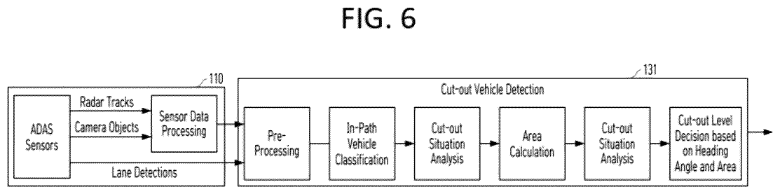

FIG. 6 is a diagram schematically showing a sensor data processing by the first sensor and the cut-out level determination logic by the processor according to the embodiment of the present disclosure.

Referring to FIG. 6, the first sensor 110 may include ADAS Sensors used in an Advanced Driver Assistance System, and may provide camera and radar data processed to the processor 131 of the controller 130. Further, data regarding lane information obtained by lane detection may also be provided to the processor 131.

The processor 131 may classify whether at least a part of the front vehicle is within the driving lane of the ego vehicle (In-Path Vehicle Classification) through a pre-processing, and may determine whether the front vehicle is a cut-out vehicle (Cut-out Situation Analysis).

Further, the processor 131 may calculate the overlapping area of the front vehicle (Area Calculation), re-determine the cut-out situation, and determine the cut-out level based on the overlapping area and heading angle (Cut-out Level Decision).

According to the embodiment of the present disclosure as described above, by utilizing various sensor data of the ego vehicle, it is possible to provide providing a method and system for adjusting a cruise control mode through detection of a cut-out vehicle that can accurately determine whether the front vehicle is a cut-out vehicle, and accordingly, flexibly control the cruise control system in a cut-out situation.

Furthermore, according to the embodiment of the present disclosure, by adjusting the headway distance and the acceleration amount according to the cruise control mode step-by-step based on the cut-out level of the front vehicle, not only can the performance of the cruise control function be further improved, but also smooth cruise control driving is enabled in a cut-out situation of the front vehicle.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

1: Ego vehicle
2: Front vehicle
3: Surrounding vehicle
10: Front camera
20: Front radar
30: Corner radar
40: Speed sensor
50: Acceleration sensor
60: Steering angle sensor
100: System for adjusting cruise control mode through detection of cut-out vehicle
110: First sensor
120: Second sensor
130: Controller
131: Processor
140: ESC controller
150: EMS controller
160: Display apparatus

1. A method for adjusting a cruise control mode through detection of a cut-out vehicle, comprising:
recognizing a front vehicle and a lane;
determining whether the front vehicle is a cut-out vehicle;
if the front vehicle is the cut-out vehicle, calculating an overlapping area between a driving lane of an ego vehicle and the front vehicle;
adjusting a cruise control mode of the ego vehicle based on the overlapping area and a heading angle of the front vehicle; and
controlling driving of the ego vehicle based on the adjusted cruise control mode.

2. The method of claim 1, wherein the determining of whether the front vehicle is the cut-out vehicle comprises: determining whether at least a part of the front vehicle is within the driving lane of the ego vehicle.

3. The method of claim 2, wherein the determining of whether the front vehicle is the cut-out vehicle further comprises: receiving information regarding a longitudinal position, a lateral position, a length, a width, and the heading angle of the front vehicle.

4. The method of claim 3, wherein the determining of whether the front vehicle is the cut-out vehicle further comprises: determining whether the front vehicle is the cut-out vehicle based on the received information.

5. The method of claim 4, wherein the calculating of the overlapping area comprises:
identifying positions of four vertices of the front vehicle from the received information; and
calculating the overlapping area based on the positions of the four vertices and recognized lane information.

6. The method of claim 5, wherein the adjusting of the cruise control mode comprises: determining a cut-out level based on the overlapping area and the heading angle of the front vehicle, and
wherein the cut-out level increases as the overlapping area decreases and as the heading angle of the front vehicle increases.

7. The method of claim 6, wherein the adjusting of the cruise control mode further comprises:
calculating a headway distance between the ego vehicle and the front vehicle based on the determined cut-out level; and
calculating an acceleration amount of the ego vehicle based on the determined cut-out level, and
wherein the headway distance and the acceleration amount are calculated such that the headway distance decreases and the acceleration amount increases as the cut-out level increases.

8. The method of claim 7, wherein the adjusting of the cruise control mode further comprises: adjusting the cruise control mode based on the calculated headway distance and the calculated acceleration amount.

9. The method of claim 6, further comprising:
after the cut-out level is determined, displaying the determined cut-out level on a display apparatus installed inside the ego vehicle.

10. The method of claim 8, further comprising:
when the cut-out of the front vehicle is completed, resetting a surrounding vehicle located ahead of the front vehicle and located in the driving lane of the ego vehicle as a target vehicle.

11. A system for adjusting a cruise control mode through detection of a cut-out vehicle, comprising:
a first sensor configured to recognize a front vehicle of an ego vehicle and a lane;
a second sensor configured to detect body information of the ego vehicle; and
a controller comprising at least one processor configured to adjust a cruise control mode of the ego vehicle based on detection information from the first sensor and the second sensor,
wherein the controller is configured to: calculate an overlapping area between a driving lane of the ego vehicle and the front vehicle if the front vehicle is determined to be the cut-out vehicle based on the detection information from the first sensor and the second sensor; adjust the cruise control mode of the ego vehicle based on the overlapping area and a heading angle of the front vehicle;
and control driving of the ego vehicle based on the adjusted cruise control mode.

12. The system of claim 11, wherein the first sensor comprises at least one of a front camera, a front radar, or a corner radar, and
wherein information regarding a longitudinal position, a lateral position, a length, a width, and the heading angle of the front vehicle is received from the first sensor.

13. The system of claim 12, wherein the at least one processor is configured to determine whether the front vehicle is the cut-out vehicle based on the information regarding the longitudinal position, the lateral position, the length, the width, and the heading angle received from the first sensor.

14. The system of claim 13, wherein the at least one processor is configured to:
identify positions of four vertices of the front vehicle from the received information; and
calculate the overlapping area based on the positions of the four vertices and recognized lane information.

15. The system of claim 14, wherein the at least one processor is configured to determine a cut-out level based on the overlapping area and the heading angle of the front vehicle, and the cut-out level increases as the overlapping area decreases and as the heading angle of the front vehicle increases.

16. The system of claim 15, wherein the at least one processor is configured to calculate a headway distance between the ego vehicle and the front vehicle and an acceleration amount of the ego vehicle such that the headway distance decreases and the acceleration amount increases as the cut-out level increases.

17. The system of claim 16, further comprising:
an ESC (Electronic Stability Control) controller configured to perform longitudinal deceleration control of the ego vehicle; and
an EMS (Engine Management System) controller configured to perform longitudinal acceleration control of the ego vehicle,
wherein the controller is configured to control at least one of the ESC controller or the EMS controller based on the cut-out level determined by the at least one processor, to control the driving of the ego vehicle according to the adjusted cruise control mode.

18. The system of claim 15, further comprising a display apparatus configured to display the cruise control mode of the ego vehicle,
wherein the controller is configured to display the cut-out level determined by the at least one processor on the display apparatus.

19. The system of claim 17, wherein the controller is configured to reset a surrounding vehicle located ahead of the front vehicle and located in the driving lane of the ego vehicle as a target vehicle when the cut-out of the front vehicle is completed.

20. A non-transitory computer-readable recording medium that records a program for executing a method for adjusting a cruise control mode through detection of a cut-out vehicle on a computer, the method comprising:
recognizing a front vehicle and a lane;
determining whether the front vehicle is a cut-out vehicle;
if the front vehicle is the cut-out vehicle, calculating an overlapping area between a driving lane of an ego vehicle and the front vehicle;
adjusting a cruise control mode of the ego vehicle based on the overlapping area and a heading angle of the front vehicle; and
controlling driving of the ego vehicle based on the adjusted cruise control mode.
